(19) United States
(12) Patent Application Publication
(10) Pub. No.: US 2025/0174016 A1
(43) Pub. Date: May 29, 2025

(54) Automatic Production of a Digital Twin

(71) Applicant: STILL GmbH, Hamburg (DE)

(72) Inventors: Patrick Erbts, Buchholz Nordheide (DE); Ralf König, Adendorf (DE); Bengt Abel, Lüneburg (DE); Yan Rudall, Hamburg (DE); Dennis Schüthe, Buchholz (DE); Mohamed Bakr, Hamburg (DE)

(21) Appl. No.: 18/843,173

(22) PCT Filed: Feb. 9, 2023
(86) PCT No.: PCT/EP2023/053206

§ 371 Date: Aug. 30, 2024

(30) Foreign Application Priority Data
Mar. 3, 2022 (DE) 10 2022 105 079.3

(51) Int. Cl. G06V 10/82; G06T 7/70; G06V 20/00

(52) U.S. Cl. CPC G06V 10/82; G06T 7/70; G06V 20/36; G06V 2201/06

(57) ABSTRACT

A method for the automatic production of a digital twin of at least one section of a building interior using at least one robot which is located in the interior of the building, includes the at least one robot having at least one sensor for the capture of a robot environment in the building interior. In the robot environment, there is at least one object that is classified in at least one object type from a number of predetermined object types. The method has the following features: capture of the robot environment by the at least one sensor of the robot to obtain captured environment data; and association of at least one object type with the object in the robot environment by means of a neural network on the basis of the environment data. The neural network is configured to recognize object types, and is executed by a processor.

### CROSS-REFERENCE TO RELATED APPLICATIONS

This application is the United States national phase of International Patent Application No. PCT/EP2023/053206 filed Feb. 9, 2023, and claims priority to German Patent Application No. 10 2022 105 079.3 filed Mar. 3, 2022, the disclosures of which are hereby incorporated by reference in their entireties

### BACKGROUND OF THE INVENTION

### Field of the Invention

The invention relates to a method for automatically producing a digital twin of at least one section of a building interior using a robot, and a data processing device for the automatic production of a digital twin of at least one section of a building interior using a robot.

### Description of Related Art

In intralogistics operations such as the internal flow of materials or in a warehouse, for example, for example, automated robots and partly automated industrial trucks such as forklift trucks and similar vehicles are being used with increasing frequency. For automated or partly automated tasks, however, 3D maps of the robot environment must be prepared. In conventional methods for mapping a robot environment, however, manual processing steps are necessary, and refreshed data inputs are necessary to update the map, as a result of which it cannot be guaranteed that the 3D map will be automatically updated and therefore up to date. In addition, the robot environment to be mapped must be closed during the preparation of the map. In conventional methods, for example, dynamic objects such as additional robots or people are considered to be disruptive during the preparation of the map and are not permitted in the robot environment to be mapped during the preparation of the map. Special sensor hardware is also frequently necessary for mapping, as a result of which existing sensors cannot be used. This can be due on one hand to a lack of the capability to merge different data sources or improper locations of the individual sensors, and on the other hand to deficient distributability of the process of producing the map, for example on account of the large quantities of data and limited data transmission capabilities. In conventional methods, the use of 3D maps is also limited because no semantic information and its location in the 3D maps can be included.

### SUMMARY OF THE INVENTION

The object of this invention is to provide an efficient generation of a digital twin of a robot environment of a robot.

According to a first aspect, the object of the invention is accomplished by a method for the automatic production of a digital twin of at least one section of a building interior using at least one robot which is located in the interior of the building, wherein the at least one robot has at least one sensor for the capture of a robot environment in the building interior, wherein there is at least one object in the robot environment, wherein the object is classified in at least one object type from a number of predetermined object types, and wherein the method has the following features: capture of the robot environment by the at least one sensor of the robot to obtain the captured environment data; classification of the object in the robot environment in at least one object type by means of a neural network on the basis of the environment data, wherein the neural network is configured to recognize object types, wherein the neural network is executed by a processor; and linking of the classified object type with position information which indicates a position of the object to create the digital twin.

The building interior can, in particular, be a warehouse, an assembly facility, an industrial area within a building or a sales area or a space used for industrial purposes. A space used for industrial purposes can, in particular, be a space with an interior area which can have in particular the properties of a warehouse, an assembly facility and/or an industrial area within a building or a sales area.

Preferably, at least one robot can mean a single robot, two robots or a plurality of robots.

In particular, at least one sensor can mean a single sensor, two sensors or a plurality of sensors or a sensor array.

In particular, at least one object type can mean a single object type, two object types or a plurality of object types.

The preceding and following explanations apply analogously to defined outdoor areas such as warehouse storage areas, outdoor assembly areas or factory buildings.

The robot can be an industrial robot which is also configured to perform additional tasks of an industrial robot such as, for example, the autonomous transport of goods or parts, the handling of loads and/or the functions of a forklift truck. However, the robot can be a stationary robot, so that the sensor captures the same environment to detect any potential changes.

In one embodiment, the robot can move in translation and/or rotation.

In one embodiment the robot is a device for the production or generation of data, such as an autonomous vehicle, for example, in particular an industrial truck or part of a vehicle, in particular, an industrial truck, or a sensor array, which can be attached for example to vehicles, conveyor belts or racks, or can be carried by persons.

In one embodiment, the processor is implemented in the robot, whereby the at least one classified object type is sent to a data processing device via a communications network, and wherein the data processing device links the at least one classified object type with the position information.

In one embodiment, the robot sends the captured environment data via a communications network to a data processing device, wherein the processor is implemented in the data processing device and wherein the data processing device links the at least one classified object type with the position information.

In one embodiment, the data processing device is a server, for example a cloud server.

In one embodiment, an output of the neural network is a digital feature set which represents the classified object type.

In one embodiment, the position information is information obtained from a global positioning system on a position of the robot or the position information is a position of the object, or the processor determines the position information from the environment data captured.

Position information can in particular mean information regarding the x-axis, the y-axis and the z-axis or a spatial axis or a plurality of spatial axes of a coordinate system. Particularly preferably, position information can mean the information that preferably comprises, in addition to the information regarding the x-axis, the y-axis and the z-axis, information regarding a three-dimensional angular position, in particular information regarding rotation around the x-axis, the y-axis and/or the z-axis.

For example, the position information can be a GPS position of a robot.

In one embodiment, the object has an attribute that is captured by the sensor in the environment data, or the robot has an additional sensor for the capture of the attribute, in particular a laser scanner that outputs attribute data wherein the processor is configured to detect the attribute in the environment data or the attribute data.

In one embodiment, the attribute is a geometric characteristic of the object, in particular a geometric shape or a geometric expanse, or an object label or an object orientation.

In one embodiment, the processor is configured to recognize the attribute on the basis of pattern recognition or on the basis of the neural network or on the basis of an additional neural network that is configured to detect attributes.

In one embodiment, the attribute with the associated object type is linked with position information.

In one embodiment, the linking of the associated object type with the position information is accomplished by an association of the position information with the object type or by an input of the position information in a digital map.

In one embodiment, at least one additional object is located in the robot environment, wherein at least one additional object type of the at least one additional object is identified by the execution of the neural network on the processor, and wherein the location information or additional location information is linked with the at least one additional object type.

Preferably, the object type can in particular be a conventional object type in the specific application, preferably a pallet, a robot, a wall, an aisle, a shelf, a door or an information sign.

In one embodiment, the object type is a pallet, a robot, a wall, an aisle, a shelf, a door or an information sign.

According to a second aspect, the object of the invention is accomplished by a robot which is located in a building interior, with at least one sensor to capture a robot environment in the building interior, wherein at least one robot is located in the robot environment, wherein the object is associated with at least one object type from a quantity of predetermined object types; a processor which is configured to associate an object type with the object in the robot environment by means of a neural network on the basis of the environment data, wherein the neural network is configured to recognize object types; and wherein the processor is further configured to link the at least one associated object type with position information which indicates a position of the object to create the digital twin.

In one embodiment, the object has an attribute that is captured by the sensor in the environment data, or the robot has an additional sensor for the capture of the attribute, in particular a laser scanner, which outputs attribute data, wherein the processor is configured to detect the attribute in the environment data or the attribute data.

According to a third aspect, the object of the invention is accomplished by a data processing device for the automatic production of a digital twin of at least one section of a building interior using at least one robot which is located in the building interior, wherein the robot has at least one sensor for capturing a robot environment in the building interior, wherein at least one object is located in the robot environment, wherein the object is associated with at least one object type from a quantity of predetermined object types, wherein the data processing device has the following features: a communication interface to receive environment data from the at least one robot via a communication network, wherein the environment data captured represents the robot environment scanned; a processor which is configured to associate at least one object type with the object in the robot environment by the execution of a neural network on the basis of the environment data, wherein the neural network is configured to recognize object types, and wherein the processor is further configured to link the at least one associated object type with position information that indicates a position of the object to create the digital twin.

According to a fourth aspect, the object of the invention is accomplished by a computer program to carry out the method according to the first aspect when the computer program is executed by means of a processor.

The embodiments cited for the object of the first aspect are also embodiments for the object of the second aspect, the object of the third aspect and the object of the fourth aspect.

The embodiments cited for the object of the second aspect are also embodiments for the object of the first aspect, the object of the third aspect and the object of the fourth aspect.

### BRIEF DESCRIPTION OF THE DRAWINGS

The terms Fig., Figs., Figure, and Figures are used interchangeably in the specification to refer to the corresponding figures in the drawings.

The invention is described in greater detail below with reference to exemplary embodiments and the accompanying figures, in which:

FIG. 1a is a flow chart that illustrates the steps of a method for the automatic production of a digital twin of at least one section of a building interior using a robot according to one embodiment;

FIG. 1b is a schematic view of a robot according to one embodiment and a data processing device according to one embodiment in a communication network;

FIGS. 1c-e are schematic views of robots according to embodiments;

FIG. 2 is a schematic view of implementation steps by robots according to one embodiment and by a data processing device according to one embodiment; and

FIG. 3 is a schematic view of a system architecture of robots according to one embodiment of a data processing device according to one embodiment and an additional data processing device according to one embodiment.

### DESCRIPTION OF THE INVENTION

The description below refers to the accompanying figures, which form a part of the description and illustrate specific embodiments in which the invention can be realized. It goes without saying that other embodiments can be used and structural or logical modifications can be made without going beyond the scope of the present invention. The following detailed description is therefore not intended to be understood in a restrictive sense. It also goes without saying that the features of the different exemplary embodiments described below can be combined with one another unless specifically indicated otherwise.

The aspects and embodiments of the present invention are described with reference to the accompanying figures, in which the same reference numbers generally relate to the same elements. In the following description, for purposes of explanation, numerous specific details are presented to convey a detailed understanding of one or more aspects of the present invention.

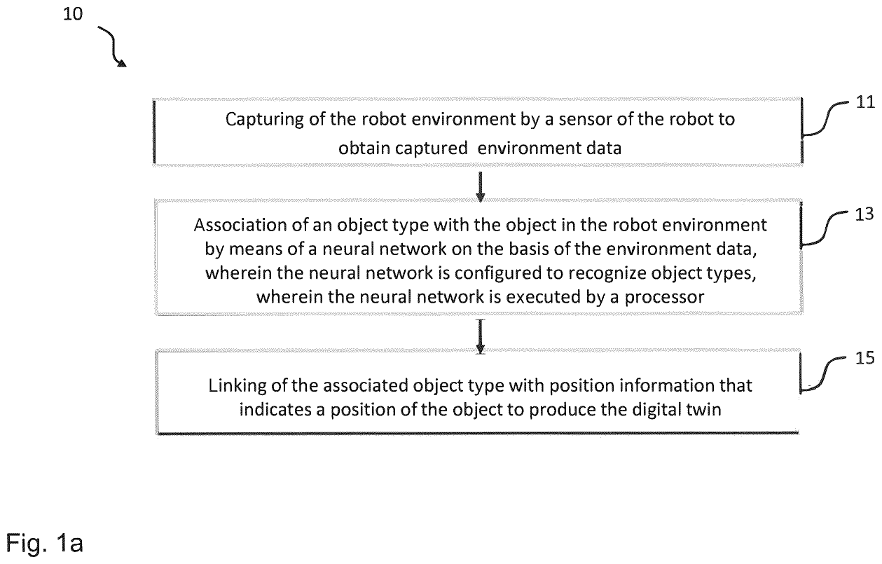

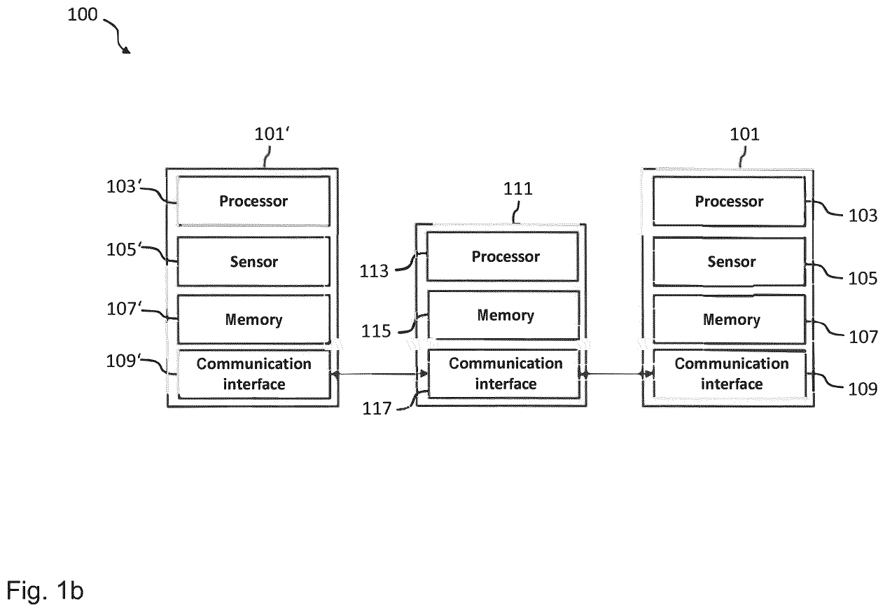

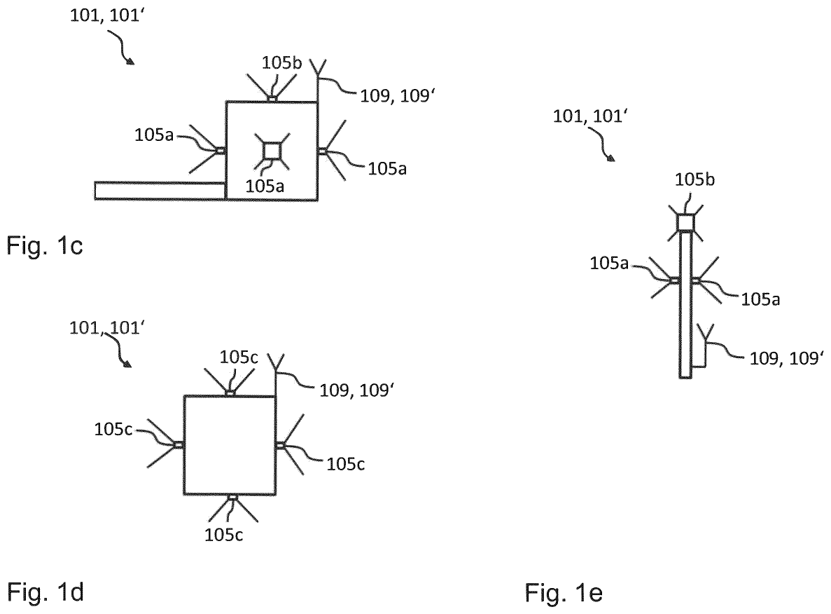

FIG. 1a is a flow chart that illustrates the steps of a method 10 for the automatic production of a digital twin of at least one section of a building interior using a robot according to one embodiment. The robot 101, 101′, which is located in the interior of the building, has a sensor 105, 105′ to capture a robot environment in the interior of the building. At least one object is located in the robot environment, wherein the object is associated with one object type from a number of predetermined object types. The method 10 has the following features: capture 11 of the robot environment by the at least one sensor of the robot 101, 101′ to acquire environment data; association 12 of at least one object type with the object in the robot environment by means of a neural network on the basis of the environment data, wherein the neural network is configured for the recognition of object types, wherein the neural network is executed by a processor 103, 103′; 113; and linking 15 of the associated object type with position information that indicates a position of the object to produce the digital twin.

FIG. 1b shows a schematic view of a robot 101, 101′ according to one embodiment and a data processing device 111 according to one embodiment in a communication network 100.

As explained in greater detail below, a plurality of robots 101, 101′ can be configured to communicate via a communication network 100 with a data processing device 111 to produce the digital twin (also called a map below).

The robots 101, 101′ can each comprise corresponding first communication interfaces 109, 109′, and the data processing device 111 can comprise a second communication interface 117 to send sensor data from the sensors 105, 105′ of the robot 101, 101′ via the communication network 100 for example, via a wired or wireless connection. As described in greater detail below, the sensor data can be pre-processed by corresponding first processors 103, 103′ of the robots 101, 101′. For the storage of the sensor data, the pre-processed data and the digital twin, the robots 101, 101′ can have corresponding first non-volatile memories 107, 107′ and the data processing device 111 can have a second non-volatile memory 115. For the further processing of the pre-processed data and/or of the sensor data 105, 105′, the data processing device 111 can comprise a second processor 113. The non-volatile memories 107, 107′, 115 can be configured to store data and any executable program code which, when it is run by the corresponding processor 103, 103′, 113, causes at least one of the processors 103, 103′, 113 to perform the functions, operations and processes described below.

The robots 101, 101′ can comprise more than one sensor 105, 105′. The sensor 105, 105′ can be a 3D sensor, for example a 3D lidar sensor, a 3D depth-of-field camera, a radar sensor, an ultrasound sensor or a stereo camera, and can generate distance information, in particular angular distance information, of the objects. Furthermore, the sensors 105, 105′ can comprise a sensor to recognize attributes, for example a laser scanner that is configured to output attribute data. Furthermore, the robots 101, 101′ can comprise an Internal Measurement Unit (IMU) or an odometry sensor system to detect a movement and/or position of the sensors 105, 105′.

As described in greater detail below, the implementation steps for the production of the digital twin or of the map can be distributed over the first processors 103, 103′ of the robots 101, 101′ and a second processor 113 of the data processing unit 111.

FIGS. 1c-e are schematic views of robots according to embodiments.

As shown in FIGS. 1c and 1d, the robot 101, 101′ can be an autonomous mobile robot (AMR) and the robot 101, 101′ can comprise a plurality of sensors 105a-c, which by overlapping the field of vision of the individual sensors 105, 105′ can cover a common field of view. As shown in FIG. 1c, the robot 101, 101′ can comprise 2D color cameras 105a as sensors 105, 105′, and the robot 101, 101′ can comprise a 3D lidar sensor 105b as an additional sensor 105, 105′. As shown in FIG. 1d, the sensors 105, 105′ can preferably be depth-of-field cameras and/or stereo cameras 105c for the generation of depth-of-field images and can be located respectively on one side of the robot 101, 101′. In alternative embodiments (not illustrated here), at least one sensor, preferably the sensors 105a-c, can also be located on load handling means, preferably a mast and/or a fork carriage and/or a fork tip. At least one sensor, preferably the sensors 105a-c, for example, can be arranged so that they have a direction of view toward the floor of the building. As shown in FIG. 1e, the robot 101, 101′ can be a sensor array with a 3D lidar sensor 105b as the sensor 105, 105′, and 2D color cameras 105a as additional sensors 105, 105′. The communications interface 109, 109′ can be configured as a wireless interface, as illustrated in FIGS. 1c-e.

In the communication network 100, a plurality of existing sensor systems such as stationary sensor systems or vehicle sensor systems of a plurality of vehicles, as well as of a plurality of locations can be used by the automated robot 101, 101′ for the production of the digital twin.

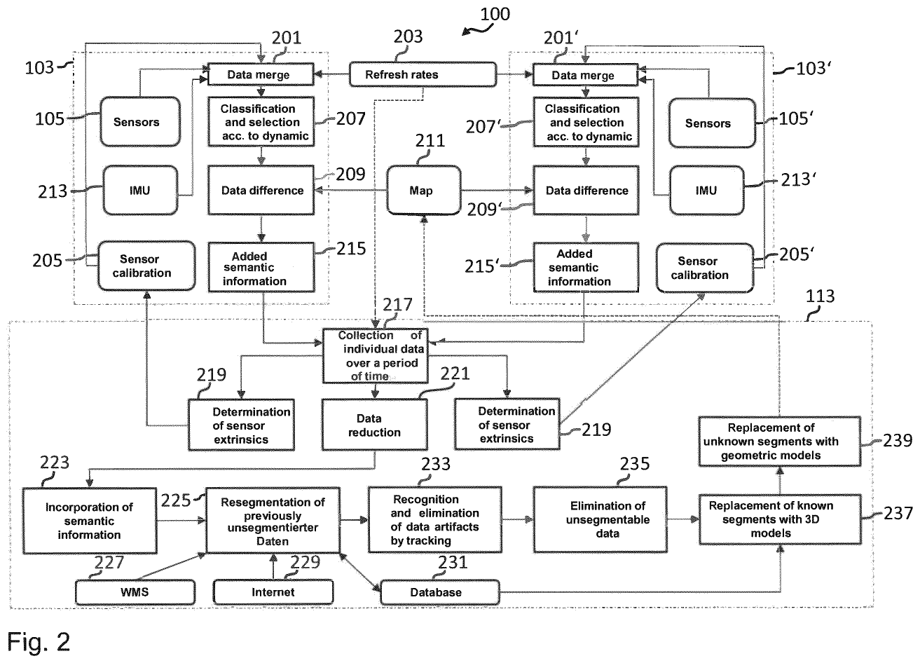

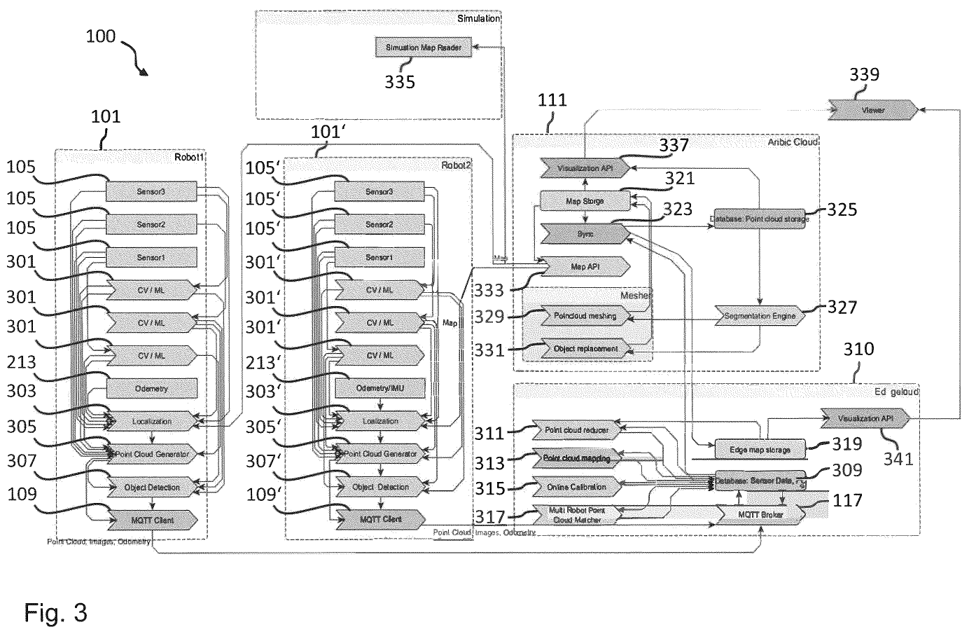

The operation of the robots 101, 101′ and of the data processing device 111 is described in greater detail below with reference to FIGS. 2 and 3. FIG. 2 shows a schematic view of implementation steps by robots 101, 101′ according to one embodiment and by a data processing device 111 according to one embodiment, and FIG. 3 shows a schematic view of a system architecture of robots 101, 101′ according to one embodiment, a data processing device 111 according to one embodiment and an additional data processing device 310 according to one embodiment. As illustrated in FIG. 3, in one embodiment the steps implemented by the second processor 113 can be distributed between the data processing device 111 and the additional data processing device 310.

FIG. 2 illustrates, by way of example, the processing steps of the first processors 103, 103′ of two robots 101, 101′. For the automatic production of the digital twin, however, even more than two robots 101, 101′, or only one robot 101, 101′, are possible. The robots 101, 101′ can be configured differently with regard to the number and/or type of sensors 105, 105′.

The respective first processors 103, 103′ can be configured to read out information via the refresh rates 203 described in greater detail below. The refresh rates can be predefined and stored in the corresponding first sensors 107, 107′ illustrated in FIG. 1b. Additionally, the refresh rates 203 of the first processors 103, 103′ based on an area of the map 211 in which the respective robots 101, 101′ are located and/or depending on movement data, for example on speed data of the motion sensors 203, 203′, can be determined and/or modified.

Based on the refresh rates 203 read out, the first processors 103, 103′ can be configured, if the corresponding robot 101, 101′ comprises more than one sensor 105, 105′, to perform a data merge 201, 201′ of the respective sensor data in a processing step, for example as illustrated in FIG. 3, into a point cloud, by a point cloud generator 305. The sensors can be configured in this manner, and based on information for the sensor calibration 205, 205′, can be calibrated so that a common or at least partly common field of view is covered by the corresponding sensors 105, 105′ of the respective robot 101, 101′. If one of the sensors 105, 105′ is a color sensor, such as a 2D color camera, for example, a color point cloud can be generated by the corresponding first processors 103, 103′.

Additionally, the respective first processors 103, 103′ can be configured to implement a processing step 207, 207′ for the classification and segmentation of the sensor data. The sensor data can be classified with regard to dynamics. A distinction can thereby be made between dynamic data which can change in a first time interval, semi-dynamic data which can change in a second time interval, and static data which can change neither in the first nor in the second time intervals. Dynamic data can be associated, for example, with vehicles or persons, semi-dynamic data can be associated with goods, for example, and static data can be associated with shelves or walls, for example. The second time interval can thereby be longer than the first time interval.

Attributes or semantic information in the sensor data can further be detected by the module 207, for example by pattern recognition. Attributes or semantic information in this context means what types of an object, such as a pallet, vehicle, person or shelf, can be recognized, for example based on a geometric shape or the size of the object and/or any numbering and/or labeling of the object. The semantic information or the attributes can further include an object orientation. The respective first processor 103, 103′ can be configured to specify and/or to modify the corresponding refresh rates 203 of the sensors based on the attributes or semantic information.

For the classification and segmentation described above and/or for the recognition of the semantic information, the respective first processor 103, 103′ can be configured to implement a corresponding first neural network 307, 307′, which is configured for machine learning and/or computer vision. As illustrated in FIG. 3, the respective neural network 307, 307′ can comprise sub-networks 301, 301′ that can be associated with specific individual sensors 105, 105′ of the corresponding robot 101, 101′. The respective first neural network 307, 307′ and the sub-networks 301, 301′ can be trained by means of objects that are typically found in warehouses, such as sensor-specific training, for example, and can therefore be configured to recognize objects in a warehouse. The module 207 can be configured to discard sensor data that does not correspond to a specific classification according to the dynamic response, which is specified on a class-specific basis with the refresh rates 203. The sensor data can therefore be reduced by the module 207.

As illustrated in FIG. 3, the sub-networks 301, 301′ can also be configured before the data fusion 201 for the localization 303, to generate localization information based on the motion data of the motion sensors 213, 213′ of the respective robot 101, 101′. Therefore, the corresponding sensor data 105, 105′ can be associated with a position on the map by a localization 303 of the corresponding robot 101, 101′. In one embodiment, the localization 303 can alternatively or additionally be based on the attributes or semantic information.

The corresponding first processor 103, 103′ can further be configured to implement a processing step 209 in which the corresponding first processor 103, 103′ is configured to determine any differences between the sensor data and the map 211 of the environment, and to further process only those areas of the map 211 that have changed with respect to the map 211.

The corresponding first processor 103, 103′ can further be configured to implement an additional processing step 215. In the additional processing step 215, the information on the class and the attributes or semantic information from the processing step 207, as well as data from motion sensors 213, 213′, can be added to the sensor data. Via the respective first communication interfaces 109, 109′ of the corresponding robots 101, 101′, the corresponding first processor 103, 103′ can be configured by means of a pre-defined transmission protocol, such as MQTT, for example, to send the thus supplemented sensor data to the data processing device 111.

The second processor 113 of the data processing device 111 can be configured, in a processing step 217 for the collection of the individual data, via the second communication interface 117 by means of the pre-defined transmission protocol of the data processing device 111 to receive the sensor data pre-processed by the respective first processors 103, 103′. In the second memory 115 of the data processing device 111, the data from the robots 101, 101′ which is received in time intervals according to the current refresh rate 203 by the second communication interface 117 and, depending on the type of the corresponding sensors 105, 105′, consists preferably of images and/or point clouds and/or semantic information and/or attributes, in particular from processing step 215, is stored individually. In the second memory 115 of the data processing device 111, the data can be collected and stored in a data repository, for example in a database 309, with a time stamp. The data collected can be regularly forwarded to the modules described below for analysis on the basis of a metric, for example the quantity of data, the distance moved by the robots 101, 101′ after a time interval determined by the second processor as a function of the refresh rates 203, the environment, an assessment of the change of the environment determined on the basis of the data collected and/or of the map areas of the map 211. In one embodiment, the forwarding of the collected data can be limited to a maximum of once per meter of movement of the robots 101, 101′ and/or to a range of a time interval from 30 seconds to 5 minutes. These values can be a function of the environment or areas of the map 211. In environments or areas of the map 211 with relatively many changes, the analysis can be conducted correspondingly more frequently than in environments in which little or nothing changes.

The processor 113 of the data processing device 211 can be configured to implement an online calibration module 315 for self-monitoring of the respective robots 101, 101′. The online calibration module 315 makes it possible, in a processing step 219, to achieve an online calibration of the corresponding sensors 105, 105′ of the respective robots 101, 101′. The individual data of the sensors can be correlated with one another on the basis of the route traveled. For this purpose, the online calibration module 315 can implement a suitable method, for example a Simultaneous Localization and Mapping (SLAM) process for each sensor 105, 105′. Based on the trajectories of the sensors 105, 105′ and the information that the corresponding sensors of the respective robots 101, 101′ are permanently coupled to one another, their movement must also be identical. By means of calibration, for example extrinsic calibration, a conclusion can therefore be reached on how the sensors 105, 105′ are oriented with respect to each other. For this purpose, the second processor 113 can calculate differences from the individual data of the sensors 105, 105′ in question. The greater the precision with which the time stamp of the individual sensor systems is known, the more accurate the calibration can be. The calibration can be transmitted via the first and second communications interfaces 109, 109′, 117 to the respective robots 101, 101′, as corresponding additional sensor system calibration 205, 205′. The additional sensor calibration 205, 205′ can then be compared with the prior, for example initial, sensor calibration 205, 205′ by the respective first processors 103, 103′. If the difference is clearly too great, the corresponding robot 101, 101′ can be calibrated to the additional sensor calibration 205, 205′, and/or the presence of a potential error may be determined and responded to by a suitable system reaction, such as a shutdown of operation, for example.

The second processor 113 can also be configured to perform data reductions in a processing step 221. For this purpose, the second processor 113 can implement a point cloud mapping module 313. The individual data from one of the robots 101, 101′ forwarded by the point cloud mapping module 313 can thereby be compiled into an overall point cloud map. The result of this process can therefore be a significant quantity of data. The individual data can thereby represent sections of this overall point cloud map. The second processor 103 can be configured to analyze a change in the overall point cloud map compared to the current map 211, and to decide, based on the analysis of the change, whether the overall point cloud is reprocessed. Dynamic objects such as vehicles and persons, for example, are eliminated from the map or are transferred into a separate map. The final point cloud map can be written back into the database 309 and the individual data collected up to the creation of the point cloud map can be deleted. New individual data can then be incorporated together with the point cloud map into a new point cloud map in subsequent runs, based on the forwarding of the data collected, which is controlled on the basis of the time interval.

The second processor 113 can also implement a Multi-Point Cloud Matcher Module 317, which works similar to the Point Cloud Mapping Module 313. Here, final point clouds from different robots 101, 101′ are combined, while on the other hand the Point Cloud Mapping module 313 uses the data of one robot 101, 101′. In one embodiment, the data from a plurality of robots 101, 101′ is combined directly in the Point Cloud Mapping module 313.

The second processor 113 can implement a Point Cloud Reducer module 311 for further data reduction. The task of the Point Cloud Reducer module 311 is to optimally reduce the data volume of a point cloud as much as possible. For this purpose, a further verification with regard to the dynamics of the objects can be performed, for example to filter out dynamic objects or static objects. For example, a further reduction of the data volume can be achieved if dynamic objects such as vehicles and/or persons are removed. An additional possible approach to reducing the quantity of data is the use of AI algorithms using an encoder-decoder principle. The AI algorithms can be trained so that objects can be detected in their entirety. In the encoder, the data quantities can be reduced essentially to features that are genuinely required by the neural networks described below, such as Deep Neural Networks, to locate and recognize objects such as vehicles, pallets etc. These features would be sufficient for the creation of the map. On account of a potential loss of information by the features from a “dense” (i.e. densely populated) map to a “sparse” (i.e. sparsely populated) map, the feature reduction can also be applied in the reverse processing direction, and the point cloud can be re-extracted from the features, for example by means of the neural network and a decoder.

As illustrated in FIG. 3, the data processing device 111 can be in communication with the additional data processing device 310 via the second communication interface 117 for synchronization 323. For this purpose, the data-reduced point cloud can be stored in a database 325 of the data processing device 111. Furthermore, the map 211 generated by the data processing device 111 can be deposited in a map memory 321 of the data processing device 111 and synchronized with a map memory 319 of the additional data processing device 310. The maps can thereby be once again fed into the Point Cloud Reducer module 311 via the map memory 319 of the additional data processing device 310 to make possible, as described above, the fusion into a new point cloud.

In one embodiment, the functionalities and components of the additional data processing device 310 can also be included in the data processing device 111, as illustrated in FIG. 2. As a result of the distribution between the data processing device 111 and the additional data processing device 310, the individual data of the sensors 105, 105′ can remain on the additional data processing device 310, as a result of which it becomes possible to reduce the data traffic between the data processing device 111 and the additional data processing device 310, for example precisely when there is a plurality of additional data processing devices 310.

The second processor and/or the data processing device 111 can further be configured in a processing step 223 to effect a merging of the attributes and/or semantic information. Instance references that were taken over from the individual data can thereby be reduced. For example, a numbering 1 to 5 of pallets of first individual data and a numbering 1 to 5 of pallets of second individual data can be reduced to a numbering 1 to 10 in the merged data. Segmentation instances can also be merged. For example, the left half of a shelf in the first individual data and the right half of a shelf in the second individual data can be identified as a single shelf in the merged data. Furthermore, based on a difference model between the map of map 211 and the merged point cloud, previously segmented and recognized objects from the point cloud can be subtracted from the point cloud and only the unknown objects forwarded to a segmentation engine 327, thereby achieving a separation of the data volume into a segmented data volume and an unsegmented data volume.

The segmentation engine 327 can be configured to load the point cloud maps for segmentation. The resulting segmentation is not only by objects; individual objects can also be distinguished from one another. For example, if there are ten pallets located next to one another, for the segmentation all objects combined can be given the label “pallet”. However, distinctions can continue to be made between the individual pallets. For example, each pallet can be labeled “pallet” although it can also be given a sequence number from 1 to 10. This information is used for further processing. The segmentation engine 327 can use a machine-learning approach for the segmentation and implement an additional neural network.

The segmentation engine 327, in a processing step 225, can thus re-segment the unsegmented data volume in which the class or object type is not yet known. Therefore, an independent object type can be assigned. For example, the floor can be assigned the same object type all over, or in specific areas in the environment, or goods can be segmented into a point set. By means of communication with a database 231, on the basis of the current resegmentation and/or the resegmentation of a previous run, the objects can be specifically labeled, for example manually. For the resegmentation, an object type can thereby be specified and stored in a CAD model. The segmentation engine 327 can also detect tags on goods, and on that basis can update information from a Warehouse Management System (WMS) 227 and/or other data sources, such as the Internet 229, for example. Via the Internet 229, and based on RGB image data, for example based on the color point cloud, a search can be conducted on search engines such as Google, for example, and a corresponding matching of information can be performed. The segmentation engine 327 can also be configured to query, via the Warehouse Management System 227, the positions of goods to identify the goods in question and, via the database 231, to query the available map 211 information such as, for example, a layout of the building with a dedicated coordinate system, to optimize the map to existing coordinate systems. In one embodiment, the second processor 113 assigned to the additional neural network of the segmentation engine 327 is more powerful than the respective first processors 103, 103′, as a result of which a more detailed segmentation and therefore a larger number of classes can be achieved.

To train the additional neural network, on one hand access can also be had to earlier data that has already been labeled. The segmentation engine 327 can further comprise a data labeler which is configured to label special load carriers or goods that are to be segmented, to train the additional neural network specifically on this data. The segmentation engine 327 for object recognition can also be coupled to the customer's CAD system so that data for objects can be entered directly into the map. Further, additional information about goods can be queried via the WMS 227, for example system information about their properties. It is therefore possible, for example, to search for the product type directly on the Internet 229, for example, to thereby obtain additional training data, and on that basis to also quickly train the additional neural network on new objects.

The segmentation engine 327 can further be configured in a processing step 233 for segmentation by means of temporal information. The position of all objects or points that cannot be assigned to an object can thereby be tracked over time. Points/objects that do not move over a defined period of time can then be classified as static. Therefore, points that result from data artifacts can also be removed. Data that cannot be combined by the segmentation engine 327, for example because the noise of the sensors 105, 105′ has led to the absence of discrete points, can then be removed in a processing step 235.

The second processor 113 can further be configured to implement a method step 237 for the replacement of known segments by 3D models. As illustrated in FIG. 3, the data processing device 11 can comprise an object replacement module 331 for this purpose. Objects in a warehouse such as pallets, shelves or box pallets, for example, can thereby be replaced by a 3D representation such as a CAD file, for example. This makes possible mapping from the point cloud to the 3D map 211. The map 211 can be stored in the map memory 321 of the data processing device 111 and as described above can also be reflected back to the additional data processing device 310. The position and content of goods are also known from the WMS 227, as a result of which this information can be simplified into models such as CAD models, for example, and can also be integrated into the map 211.

The second processor 113 can be further configured to implement a method step 239 for the replacement of unknown segments by geometric models. As illustrated in FIG. 3, for this purpose the data processing device 111 can comprise a point cloud meshing module 329. In this module, large areas of the point cloud can be combined into a polygonal mesh, for example to replace the floor with this polygonal mesh. It thereby becomes possible to reduce the volume of points because otherwise a very large number of points would be required to describe and represent the whole floor. The polygonal mesh itself can be formed from only a few vertices, of the type known from gaming engines, for example. Further, other large areas such as walls, ceilings, as well as pallets, shelves and goods, to the extent they have not yet been replaced by the object replacement module 331, can also be represented on the map.

By means of a Map API 331, the map 211 can again be distributed to the robots 101, 101′, and/or the map 211 can be used in a simulation via a map reader 335. By means of a corresponding interface, the map 211 can also be made available to other programs, such as CAD programs or warehouse management systems 227, for example. In one embodiment, the Map API 333 can also be integrated into the additional data processing device 310 to supply the robots 101, 101′ with the map update of the map 211. The Map API can be used via interfaces and/or standardized protocols such as VDA5050 to distribute the map 211. The robots 101, 101′ can be configured to locate themselves by means of the map 211, for example via SLAM.

Visualization interfaces 337, 341 of the data processing device 111, 310 can be used to display the generated map 211, i.e. the 3D twin of the warehouse, via a defined interface 339 and thereby enable the user to move around virtually in the warehouse. The link between the user and the defined interface 339 can be established via an Internet connection and user-specific access data. The display can appear on a device such as a tablet, mobile phone, PC or by means of virtual reality (VR) and augmented reality (AR), for example in the form of an AR/VR device. The advantage of an AR device is that it can be carried directly into the warehouse and the map 211 and the real environment can be superimposed on one another. The map 211 can further support a live inventory of the warehouse, or a manual inventory can be conducted, preferably by means of AR devices.

For the representation of dynamic objects on the map 211, the method steps described above with reference to FIGS. 2 and 3 can be based on a filtering of static and semi-dynamic objects. The dynamic objects can then be displayed in the updatable map 211 or hidden.

Therefore, special hardware that interrupts productive operations to generate a digital image of the environment is no longer required. The entire working process can be automated without the need for any intervention or processing of data by humans. The system can therefore be encapsulated and a plurality of functions can be performed simultaneously, such as the live mapping of the environment and the related digital services such as, for example, a live inventory, localization and simulation of the real environment. Costs and processing times can thus be reduced and data can be collected that is absolutely necessary for an advanced digitization by means of artificial intelligence.

1. A method for the automatic production of a digital twin of at least one section of an interior of a building using at least one robot which is located in the interior of the building, wherein the at least one robot has at least one sensor for scanning of a robot environment in the interior of the building, wherein in the robot environment there is at least one object, and wherein the at least one object is classified in at least one object type from a number of predetermined object types, the method comprising:
capturing of the robot environment by the at least one sensor of the at least one robot to receive captured environment data;
associating the at least one object type with the at least one object in the robot environment by use of a neural network and based on the captured environment data, wherein the neural network is configured to recognize object types and is executed by a processor; and
linking the at least one object type with position information that indicates a position of the at least one object to create the digital twin.

2. The method according to claim 1, wherein the processor is implemented, and wherein, when linking the at least one object type with the position information, the at least one object type is sent to a data processing device via a communication network, and the data processing device links the at least one object type with the position information.

3. The method according to claim 1, wherein the processor is implemented in a data processing device, and wherein, when linking the at least one object type with the position information, the robot sends the captured environment data via a communication network to the data processing device, and the data processing device links the at least one object type with the position information.

4. The method according to claim 1, wherein an output of the neural network represents a digital feature set that represents the at least one object type.

5. The method according to claim 1, wherein the position information is: information obtained from a global positioning system regarding a position of the robot, a position of the at least one object, or determined from the captured environment data.

6. The method according to claim 1, wherein: (i) the at least object has an attribute that is captured by the at least one sensor in the captured environment data, or (ii) the robot has an additional sensor for the capture of the attribute, and that outputs attribute data; and wherein the processor is configured to detect the attribute in (i) the captured environment data or (ii) the attribute data.

7. The method according to claim 6, wherein the attribute is a geometric characteristic of the at least object, the attribute comprising at least one of: a geometric shape, a geometric expanse, an object label or an object orientation.

8. A method according to claim 6, wherein the processor is configured to recognize the attribute on a basis of pattern recognition, the neural network, or an additional neural network that is configured to recognize attributes.

9. The method according to claim 6, wherein the attribute, with the at least one object type, is linked with the position information.

10. The method according to claim 9, wherein the linking of the at least one object type with the position information is performed by: (i) an association of the position information with the at least one object type, or (ii) the by an entry of the position information in a digital map.

11. The method according to claim 1, wherein at least one additional object is located in the robot environment, wherein at least one additional object type of the at least one additional object is captured by the execution of the neural network on the processor, and wherein the position information or additional low information is linked with the at least one additional object type.

12. The method according to claim 1, wherein the at least one object type is a pallet, a robot, a wall, an aisle, a shelf, a door, or an information sign.

13. A robot configured to be located in on interior of a building, comprising:
at least one sensor for capture of a robot environment in the interior of the building, wherein at least one object is located in the robot environment, and wherein the at least one object is associated with at least one object type from a number of predetermined object types; and
a processor that is configured to associate the at least one object type with the at least one object in the robot environment by use of a neural network and based on the environment data, wherein the neural network is configured to recognize object types,
wherein the processor is further configured to link the at least one object type with position information that indicates a position of the at least one object to produce a digital twin.

14. The robot according to claim 13, wherein (i) the at least one object has an attribute that is captured by the at least one sensor in the environment data, or (ii) the robot has an additional sensor for capture of the attribute and that outputs attribute data; and wherein the processor is configured to detect the attribute in (i) the environment data or (ii) the attribute data.

15. A data processing device for an automatic production of a digital twin of at least one section of an interior of a building using at least one robot which is located in the interior of the building, wherein the robot has at least one sensor for capture of a robot environment in the interior of the building, wherein in the robot environment there is at least one object, wherein associated with the at least one object is at least one object type from a number of predetermined object types, and wherein the data processing device comprises:
a communication interface for reception of environment data from the at least one robot via a communication network, wherein the environment data represents the robot environment captured by the at least one sensor;
a processor configured to associate the at least one object type with the at least one object in the robot environment by the execution of a neural network and based on the environment data, wherein the neural network is configured to recognize object types, and wherein the processor is further configured to link the at least one object type with position information that indicates a position of the least one object to produce the digital twin.

16. (canceled)

17. The method according to claim 6, wherein the additional sensor is a laser scanner that outputs the attribute data.

18. The robot according to claim 14, wherein the additional sensor is a laser scanner that outputs the attribute data.
